(19) United States
(12) Patent Application Publication
(10) Pub. No.: US 2020/0279232 A1
(43) Pub. Date: Sep. 3, 2020

(54) METHOD AND SYSTEM FOR GENERATING SUPER-SOVEREIGN CURRENCY

(71) Applicants: Zhijia Xu, Xiantao (CN); Haixin Xu, Xiantao (CN); Li Liu, Xiantao (CN)

(72) Inventors: Zhijia Xu, Xiantao (CN); Haixin Xu, Xiantao (CN); Li Liu, Xiantao (CN)

(21) Appl. No.: 16/421,500

(22) Filed: May 24, 2019

(30) Foreign Application Priority Data
Feb. 28, 2019 (CN) 201910150170.0

(51) Int. Cl. G06Q 20/06; G06Q 20/38; G06Q 30/02; H04L 9/06

(52) U.S. Cl. CPC G06Q 20/065; G06Q 20/381; G06Q 30/0283; H04L 2209/56; G06Q 20/3827; H04L 2209/38; H04L 9/0637

(57) ABSTRACT

The invention discloses a method and system for generating super-sovereign currency, which extensively collects commodity transacting information, performs AI processing on the transaction list, extracts the value characteristics of all commodities to constitute the super-sovereign currency, and labels the value of the super-sovereign currency in various currencies, enables the super-sovereign currency has its own exchange rate, hereby to realize cross-currency world trade, and generates the super-sovereign currency through the world trade activity award or the consensus-recognized physical objects exchange.

### BACKGROUND OF THE INVENTION

### 1. Field of the Invention

The invention relates to the field of Internet finance, and in particular, to a method and system for generating super-sovereign currency.

### 2. Description of the Related Art

In recent years, with the continuous development of Internet finance, the process of world trade integration has accelerated, and economic and trade barriers between countries and regions have been continuously weakened. People are paying more and more attention to the super-sovereign currency with a demand on it. Generally speaking, the current world currencies with some functions of super-sovereign currency include U.S. Dollar, Euro, Renminbi, Yen and other flat currencies, and non-flat currencies such as Bitcoin, Dogecoin and Litecoin. The flat currency such as the U.S. Dollar is a compulsory currency symbol issued by an economic or political entity, which represents the wealth within the currency circulation area and has inherent defects controlled by the issuer. The issuer can manipulate the distribution of wealth within the circulation area through currency circulation, currency placement points, and currency flows, which are naturally predatory. Therefore, although the exchange rate system is established between currencies, the exchange rate of each currency is not a product of the consensus mechanism. All exchange rates are essentially controlled by the currency issuer, and the so-called market regulation is only a kind of decentralization and control behavior when the issuer does not want to manage it. Although the non-flat currency such as Bitcoin is based on the new application mode of computer technology such as blockchain distributed data storage, point-to-point transmission, consensus mechanism, encryption algorithm, etc., which has solved the problem of decentralization, de-trust, and self-management, however, the value of such currency depends only on the amount of computing work and market supply and demand; it has neither the inherent price relation with other commodities to be used as a measure of the value of other commodities, nor is it legal and mandatory, and the value and price are unrooted and risky; moreover, anonymous transaction is adopted in such currency, which are easily exploited by illegal acts such as money laundering and tax evasion, and it is difficult to recover property losses after the private key is stolen or damaged.

It is a long-standing goal of the reform of the international monetary system to create a world currency that is decoupled from sovereign states, recognized by the world consensus, highly secure, and maintains long-term currency stability, promotes the rational allocation of global resources, stimulates economic and trade activities to become active, and saves costs and improves transaction or investment efficiency. In the 1940s, Keynes proposed the idea of using 30 representative commodities as the basis for the establishment of the international currency unit “Bancor”, but unfortunately failed to implement. Later, in 1969, at the beginning of the collapse of the Bretton Woods system, the International Monetary Fund created a special drawing right to alleviate the inherent risks of sovereign currency as a reserve currency; regrettably, due to the limitations of the distribution mechanism and the scope of use, the effect is far from expected.

In short, there is a lack for the modern society of a consensus-recognized super-sovereign currency with decentralization, de-credit, security, reliability, self-management, and natural value.

### SUMMARY OF THE INVENTION

In order to solve the issues set forth, the invention provides a method and system for generating super-sovereign currency, which extensively collects commodity transacting information, performs AI processing on the transaction list, extracts the value characteristics of all commodities to constitute the super-sovereign currency, and labels the value of the super-sovereign currency in various currencies, enables the super-sovereign currency has its own exchange rate, hereby to realize cross-currency world trade, and generates the super-sovereign currency through the world trade activity award or the consensus-recognized physical objects exchange.

Further, the invention performs compliance verification on the transaction lists uploaded by all nodes, and records those in compliance in the blockchain and rewards both parties to the transaction; it performs AI processing on the transaction list in the blockchain, realizes price labeling of the same commodity in different currencies, and establishes the equivalence relation of each currency of the corresponding commodity; it constitutes all commodities into the super-sovereign currency according to the consensus weight; the list of transaction includes a list of all commodity transactions for some time prior to the operation of the method and system, and the commodity transaction includes the exchange of value for the purchase or sale of physical or virtual goods, the sale and purchase of services, the trading of currencies and other securities; the compliance verification is to generate a compliance verification standard through a consensus mechanism, and verify the compliance of the transaction list according to the standard; the compliance verification standards should include: transaction authenticity, exclusion of internal transaction, and false transaction; the sustainability of transaction requires a certain market supply of goods; the universality of transaction requires that specific transacting objects cannot be limited; the fairness of transaction requires that when the commodity pricing of a certain node deviates significantly from the market price, all trading nodes are allowed to participate freely, and the buyers and sellers determine the priority trading rights according to the quotation of the market price that is acceptable to each other and the quotation time; the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc., to establish a database indexed by the name of commodity; the same commodity refers not only to the same raw material of the manufactured goods, but also to the same or similar functions and performances of the products, the same specifications and models, and the same quality grades; the price labelling is based on the data in the database established by the AI processing of the transaction list, and the same commodity is priced in the basic unit of measurement in different currencies; the consensus weight is that when a super-sovereign currency is generated by all commodities to extract the value features, the invention determines the weight according to the geographical distribution rate, node participation rate, transaction frequency, proportion of the transaction volume, etc. of the commodity in the world trade, and it is recognized by the consensus mechanism.

Further, the invention determines the measure of value of the super-sovereign currency; it performs correspondence on the currency to the labeled price of all commodities, and the weighted average is calculated according to the weight of the corresponding commodity; the price labeling of the super-sovereign currency in each currency is completed, and an equivalence relation between different currencies based on the super-sovereign currency is established, namely, the exchange rate; it determines the issuance mechanism of the super-sovereign currency; it realizes cross-currency world trade based on the equivalence relation between different currencies based on the super-sovereign currency, and issues the super-sovereign currency through the world trade activity award or the consensus-recognized physical objects exchange; the cross-currency world trade includes both the trading activities of the currency held by the buyer node and the currency priced by the seller in different currencies, as well as the transaction activities between the consensus-recognized physical objects and the super-sovereign currency between the consensus-recognized super-sovereign currency business enterprise and the respective nodes; a super-sovereign currency business enterprise refers to an enterprise that has a good reputation and at least obtains the consensus recognition of the nodes in the circulation area of the flat currency, has the consensus-recognized physical object as a guarantee, and is willing to carry out transactions between the super-sovereign currency and consensus-recognized physical objects; the consensus-recognized object is a valuable object recognized by the consensus mechanism, including commodities such as gold and silver that can be used as currency, and physical objects that need to be reserved for future development for human development; in addition to cross-currency world trade activities, the world trade activities also include regional economic and trade activities in the same currency.

Further, the method and system for generating the super-sovereign currency adopts the distributed platform; the software and hardware are launched by the consensus of the originating node, and is announced on the whole network; all subsequent nodes are accessed, in no particular order and pari passu; all nodes can propose optimization and improvement proposals and solutions for software and hardware systems to be recognized and adopted by the consensus mechanism; the operation of the consensus-recognized system software on the hardware of the consensus-recognized super-sovereign currency business enterprise is as the system miscellaneous platform, and all node hardware can perform operation on the consensus-recognized system software to become the node platform.

A method and system for generating super-sovereign currency, comprising the following steps: S1, each node uploads the transaction list to the system platform, wherein the transaction list refers to a list of all commodity transactions for some time prior to the generation of the platform; S2, the invention performs compliance verification on the transaction lists uploaded by all nodes, if the list is in compliance enters step S3, otherwise returns to step S1; S3, the transaction lists in compliance are generated to blocks and are added into the blockchain, and both parties of the transaction are rewarded; S4, it performs AI processing on the transaction list in the blockchain; S5, it determines the weight according to the geographical distribution rate, node participation rate, transaction frequency, proportion of the transaction volume, etc. of the commodity in the world trade, and constitutes all commodities into the super-sovereign currency according to the weight after being recognized by the consensus mechanism; S6, it determines the price and value of the super-sovereign currency; it performs correspondence on the currency to the labeled price of all commodities, and the weighted average is calculated according to the weight of the corresponding commodity; the price labeling of the super-sovereign currency in each currency is completed, and an equivalence relation between different currencies based on the super-sovereign currency is established, namely, the exchange rate; S7, a world trade system with the super-sovereign currency is established as the hub and bridge with the characteristics that the super-sovereign currency naturally has the relation of the exchange rate of each currency; S8, the trading activities include both the same currency and the following cross-currency transactions: when the buyer purchases the commodity from the seller, the currency held by the buyer is converted into the currency priced by the seller to complete the transaction by the equivalence relation of each currency based on the super-sovereign currency; when the currency of the buyer is converted into the currency priced by the seller, the two parties can voluntarily trade directly between the two currencies, or the other party may voluntarily undertake the currency exchange between the buyer and the seller, and the other party converts the currency of the buyer in the transaction into the currency priced by the seller; the consensus-recognized super-sovereign currency business enterprise is responsible for the operation between the consensus-recognized physical objects and the super-sovereign currency: it acquires the consensus-recognized physical objects of the seller, generates and issues the equivalent super-sovereign currency to the seller; it sells the consensus-recognized physical objects of the buyer, withdraws and cancels the equivalent super-sovereign currency from the buyer; S9, the transaction list is uploaded by the node to the system platform, and after passing the compliance verification, the super-sovereign currency is awarded to the two parties according to the consensus-recognized award amount; the award amount is the ratio of ten thousand of the transaction amount in the super-sovereign currency; the super-sovereign currency that is awarded in the node transaction and the super-sovereign currency issued or cancelled by the consensus-recognized super-sovereign currency business enterprise are recorded in the blockchain of the super-sovereign currency list.

Further, the AI processing comprises A1: an intelligent processing module based on mathematical statistical model must be generated via the consensus mechanism to establish an AI processing system; A2: the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc., to establish a database indexed by the name of commodity; A3: the AI processing system relies on the database to calculate the price of different currencies of the basic unit of the commodity according to the recent average transaction price of the commodity, and realizes price labeling of the same commodity in different currencies.

Adopting the technical solutions above, the invention has the following advantageous effects:

1. The invention provides a commodity that can be naturally used as the currency, rather than a currency symbol. The super-sovereign currency is a general equivalent commodity that is combined according to the weight of various commodities to extract the value characteristics of the commodity. Modifying each commodity to constitute the weight of the super-sovereign currency does not change the commodity property of the super-sovereign currency.

2. The invention provides a currency with its own measure of value scale without mandatory giving. The value of the super-sovereign currency comes from the current price labelling of various currencies, which naturally has the exchange rate relation between various currencies; it is a ruler for various currencies, and the precision of the ruler continues to increase as the transaction volume increases.

3. The invention provides a currency in which all nodes jointly determine the amount of circulation without an issuer. The circulation of the super-sovereign currency depends on the transaction award and the exchange of consensus-recognized physical objects, which is directly proportional to the growth of world trade activity and the actual wealth of society and is not driven by various interest groups.

4. The invention provides a currency in which all nodes jointly determine the exchange rate between currencies. The equivalence relation between the currencies based on the super-sovereign currency depends on the balance point reached by the nodes in the long-term and extensive commercial activities through repeated competition. Any behavior that manipulates or affects the exchange rate can be and can only be achieved through transactions. The market attributes of the transaction, as well as the application of blockchain technology forces the manipulation or influence of the exchange rate to return to the origin of openness, fairness and justice.

5. The super-sovereign currency of the invention solves the security risks in anonymous transactions; first, when the node uploads the wealth of the local and foreign currencies already held itself, it needs to have a real user name via the consensus-recognized super-sovereign currency business enterprise; second, even if the node loses the account or private key, it can be retrieved through the list of transaction that have been uploaded.

6. The compliance verification standard of the transaction list, AI processing system, commodity weight, super-sovereign currency business enterprise, physical objects that can be exchanged for the super-sovereign currency, etc. involved in the invention must be generated by the public consensus mechanism, and supervised by the whole network and all nodes, which infinitely increases the difficulty of cheating.

### BRIEF DESCRIPTION OF THE DRAWINGS

FIG. 1 is a diagram illustrating the labelling of currency to the commodity and the origin and source of value of the super-sovereign currency of the invention.

FIG. 2 is a flow diagram illustrating the method and system for generating the super-sovereign currency.

### DETAILED DESCRIPTION OF THE PREFERRED EMBODIMENTS

Embodiment 1: the invention is further described hereinafter with reference to the drawings and the specific embodiment.

The invention provides a method and system for generating super-sovereign currency, which extensively collects commodity transacting information, performs AI processing on the transaction list, extracts the value characteristics of all commodities to constitute the super-sovereign currency, and labels the value of the super-sovereign currency in various currencies, enables the super-sovereign currency has its own exchange rate, hereby to realize cross-currency world trade, and generates the super-sovereign currency through the world trade activity award or the consensus-recognized physical objects exchange.

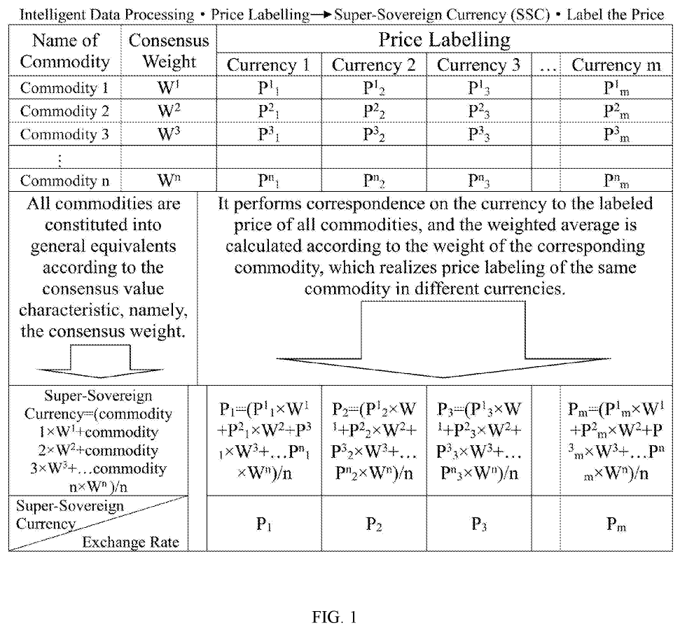

The invention performs compliance verification on the transaction lists uploaded by all nodes, and records those in compliance in the blockchain and rewards both parties to the transaction; it performs AI processing on the transaction list in the blockchain, as shown in FIG. 1, realizes price labeling of the same commodity in different currencies, and establishes the equivalence relation of each currency of the corresponding commodity.

The list of transaction includes a list of all commodity transactions for some time prior to the operation of the method and system, and the commodity transaction includes the exchange of value for the purchase or sale of physical or virtual goods, the sale and purchase of services, the trading of currencies and other securities. The time limited may be three years, or two years, one year, which is determined by the consensus mechanism. The time limit is because the transaction lists that have been uploaded for too long do not accurately reflect the purchasing power of the current currency.

The compliance verification is to generate a compliance verification standard through a consensus mechanism, and verify the compliance of the transaction list according to the standard; the compliance verification standards should include: transaction authenticity, exclusion of internal transaction, and false transaction; the sustainability of transaction requires a certain market supply of goods; the universality of transaction requires that specific transacting objects cannot be limited; the fairness of transaction requires that when the commodity pricing of a certain node deviates significantly from the market price, all trading nodes are allowed to participate freely, and the buyers and sellers determine the priority trading rights according to the quotation of the market price that is acceptable to each other and the quotation time.

The difficulty object of the generating of the block in the blockchain is not set, and the workload is not required to prove the competition of algorithm; as long as the transaction list is verified and compliant after being uploaded to the platform, the block can be generated in chronological order. The block includes the version number, the block height, the current block Hash, the previous block Hash, the timestamp of the transaction list uploaded to the platform, the Merkle root, the transaction volume and transaction data as of this block.

The items and standards of the AI processing that “the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc.” have to be recognized by the consensus mechanism.

The same commodity refers not only to the same raw material of the manufactured goods, but also to the same or similar functions and performances of the products, the same specifications and models, and the same quality grades.

The price labelling is based on the data in the database established by the AI processing of the transaction list, and the same commodity is priced in the basic unit of measurement in different currencies.

The basic unit of measurement refers to the smallest international unit of measured goods recognized by the consensus mechanism. For example, ordinary metals, grain, etc. are measured in kilograms; precious metals, processed foods, etc. are measured in grams, crude oil are measured in barrels, gasoline and diesel are measured in liters, and the like.

If the commodity n is price labelled with currency 1, currency 2, currency 3, . . . , currency m as Pⁿ₁, Pⁿ₂, Pⁿ₃, . . . , Pⁿₘ, then the value relation of currency 1, currency 2, currency 3, . . . , currency m is: Pⁿ₁=Pⁿ₂=Pⁿ₃= . . . =Pⁿₘ.

Preferably, the invention constitutes all commodities into the super-sovereign currency according to the consensus weight.

The consensus weight is that when a super-sovereign currency is generated by all commodities to extract the value features, the invention determines the weight according to the geographical distribution rate, node participation rate, transaction frequency, proportion of the transaction volume, etc. of the commodity in the world trade, and it is recognized by the consensus mechanism.

If the weight of the consensus-recognized commodity 1, commodity 2, commodity 3, . . . , commodity n is respectively W¹, W², W³ . . . Wⁿ, then the value of the super-sovereign currency is equal to (commodity 1×W¹+commodity 2×W²+commodity 3×W³+ . . . commodity n×Wⁿ)/n.

Preferably, it determines the measure of value of the super-sovereign currency; it performs correspondence on the currency to the labeled price of all commodities, and the weighted average is calculated according to the weight of the corresponding commodity; an equivalence relation between different currencies based on the super-sovereign currency is established, namely, the exchange rate.

If the labelled price with the currency 1 of the commodity 1, commodity 2, commodity 3, . . . , commodity n is P¹₁, P²₁, P³₁, . . . , Pⁿ₁, then the weighted average P₁ of the weight of the commodity corresponding to the currency 1 is equal to P¹₁×W¹+P²₁×W²+P³₁×W³+ . . . Pⁿ₁×Wₙ)/n, and so on, the weighted average of the currency 2, currency 3, . . . , currency m P², P₃, . . . , Pₘ are calculated; the average value of the string is the price labelling of currency 1, currency 2, currency 3, . . . , currency m for the super-sovereign currency, that is, the price value of the super-sovereign currency P₀ has the measure of value scale as the currency of P₁, the currency of P₂, the currency of P₃, and the currency m of Pₘ, and the expression is: P₀=P₁=P₂=P₃ . . . =Pₘ.

Preferably, it determines the issuance mechanism of the super-sovereign currency; it realizes cross-currency world trade based on the equivalence relation between different currencies based on the super-sovereign currency, and issues the super-sovereign currency through the world trade activity award or the consensus-recognized physical objects exchange.

The cross-currency world trade includes both the trading activities of the currency held by the buyer node and the currency priced by the seller in different currencies, as well as the transaction activities between the consensus-recognized physical objects and the super-sovereign currency between the consensus-recognized super-sovereign currency business enterprise and the respective nodes.

A super-sovereign currency business enterprise refers to an enterprise that has a good reputation and at least obtains the consensus recognition of the nodes in the circulation area of the flat currency, has the consensus-recognized physical object as a guarantee, and is willing to carry out transactions between the super-sovereign currency and consensus-recognized physical objects.

The consensus-recognized object is a valuable object recognized by the consensus mechanism, including commodities such as gold and silver that can be used as currency, and physical objects that need to be reserved for future development for human development.

In addition to cross-currency world trade activities, the world trade activities also include regional economic and trade activities in the same currency.

The issuance mechanism of the super-sovereign currency depends on world trade activities, and there are two distribution methods thereof: method 1, the consensus-recognized super-sovereign currency business enterprise acquires the consensus-recognized physical objects of the seller, generates and issues the equivalent super-sovereign currency to the seller; it sells the consensus-recognized physical objects of the buyer, withdraws and cancels the equivalent super-sovereign currency from the buyer; method 2, the transaction list is uploaded by the node to the system platform, and after passing the compliance verification, the super-sovereign currency is awarded to the two parties according to the consensus-recognized award amount; the award amount is the ratio of ten thousand of the transaction amount in the super-sovereign currency, for example 0.5% of the reward for the same currency transaction and 1% of the reward for the cross-currency transaction.

The issuance of super-sovereign currency (including cancellation) must be carried out by a separate blockchain; the header structure of the block includes the version number, the block height, the current block Hash, the previous block Hash, the timestamp of the transaction list uploaded to the platform, the Merkle root.

The method and system for generating the super-sovereign currency adopts the distributed platform; the software and hardware are launched by the consensus of the originating node, and is announced on the whole network; all subsequent nodes are accessed, in no particular order and pari passu; all nodes can propose optimization and improvement proposals and solutions for software and hardware systems to be recognized and adopted by the consensus mechanism; the operation of the consensus-recognized system software on the hardware of the consensus-recognized super-sovereign currency business enterprise is as the system miscellaneous platform, and all node hardware can perform operation on the consensus-recognized system software to become the node platform.

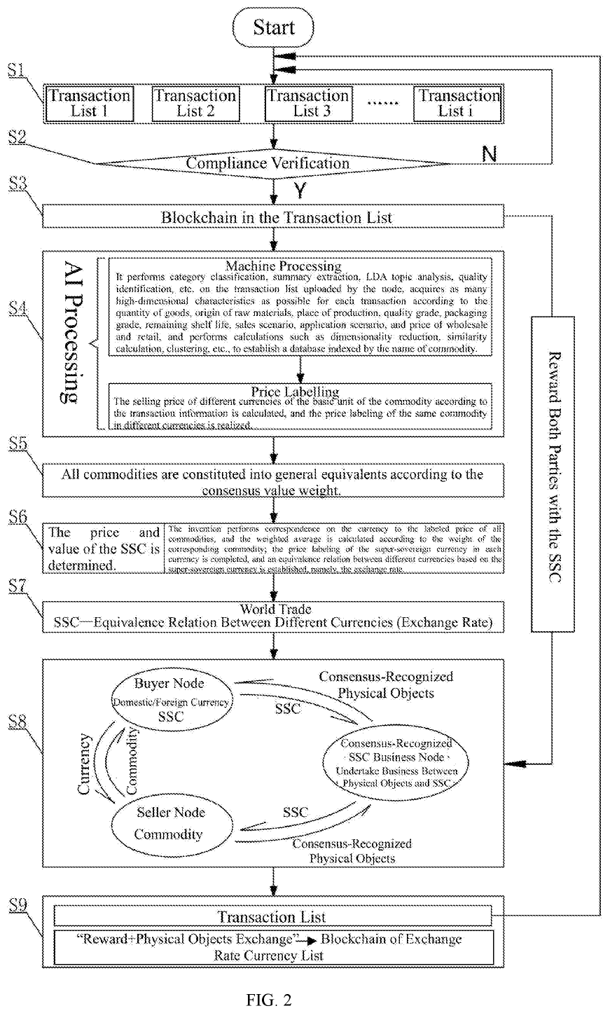

Preferably, a method and system for generating the super-sovereign currency, as shown in FIG. 2, comprising the following steps:

S1, each node uploads the transaction list to the system platform, wherein the transaction list refers to a list of all commodity transactions for 3 years prior to the generation of the platform;

S2, the invention performs compliance verification on the transaction lists uploaded by all nodes, if the list is in compliance enters step S3, otherwise returns to step S1;

S3, the transaction lists in compliance are generated to blocks and are added into the blockchain, and both parties of the transaction are rewarded;

S4, it performs AI processing on the transaction list in the blockchain, comprising:

A1: an intelligent processing module based on mathematical statistical model must be generated via the consensus mechanism to establish an AI processing system;

A2: the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc., to establish a database indexed by the name of commodity;

A3: the AI processing system relies on the database to calculate the price of different currencies of the basic unit of the commodity according to the recent average transaction price of the commodity, and realizes price labeling of the same commodity in different currencies;

S5, the invention determines the weight according to the geographical distribution rate, node participation rate, transaction frequency, proportion of the transaction volume, etc. of the commodity in the world trade, and constitutes all commodities into the super-sovereign currency according to the weight after being recognized by the consensus mechanism;

S6, it determines the price and value of the super-sovereign currency; it performs correspondence on the currency to the labeled price of all commodities, and the weighted average is calculated according to the weight of the corresponding commodity; the price labeling of the super-sovereign currency in each currency is completed, and an equivalence relation between different currencies based on the super-sovereign currency is established;

S7, a world trade system with the super-sovereign currency is established as the hub and bridge with the characteristics that the super-sovereign currency naturally has the relation of the exchange rate of each currency;

S8, the trading activities include both the same currency and the following cross-currency transactions:

when the buyer purchases the commodity from the seller, the currency held by the buyer is converted into the currency priced by the seller to complete the transaction by the equivalence relation of each currency based on the super-sovereign currency; when the currency of the buyer is converted into the currency priced by the seller, the two parties can voluntarily trade directly between the two currencies, or the other party may voluntarily undertake the currency exchange between the buyer and the seller, and the other party converts the currency of the buyer in the transaction into the currency priced by the seller;

the consensus-recognized super-sovereign currency business enterprise is responsible for the operation between the consensus-recognized physical objects and the super-sovereign currency: it acquires the consensus-recognized physical objects of the seller, generates and issues the equivalent super-sovereign currency to the seller; it sells the consensus-recognized physical objects of the buyer, withdraws and cancels the equivalent super-sovereign currency from the buyer;

S9, the transaction list is uploaded by the node to the system platform, and after passing the compliance verification, the super-sovereign currency is awarded to the two parties according to the consensus-recognized award amount; the award amount is the ratio of ten thousand of the transaction amount in the super-sovereign currency;

the super-sovereign currency that is awarded in the node transaction and the super-sovereign currency issued or cancelled by the consensus-recognized super-sovereign currency business enterprise are recorded in the blockchain of the super-sovereign currency list.

The basic principles and main features of the invention have been described above. It should be understood by those skilled in the art that the invention is not limited by the embodiments above, and that the description of the embodiments and the specification are merely illustrative of the principles of the invention. Various modifications and improvements can be made without departing from the spirit and scope of the invention, and such modifications and improvements all fall within the protection scope of the invention. The protection scope of the invention is defined by the appended claims and equivalents thereof.

1. A method and system for generating super-sovereign currency, which extensively collects commodity transacting information, performs AI processing on the transaction list, extracts the value characteristics of all commodities to constitute the super-sovereign currency, and labels the value of the super-sovereign currency in various currencies, enables the super-sovereign currency has its own exchange rate, hereby to realize cross-currency world trade, and generates the super-sovereign currency through the world trade activity award or the consensus-recognized physical objects exchange.

2. The method and system according to claim 1, wherein it performs compliance verification on the transaction lists uploaded by all nodes, and records those in compliance in the blockchain and rewards both parties to the transaction; it performs AI processing on the transaction list in the blockchain, realizes price labeling of the same commodity in different currencies, and establishes the equivalence relation of each currency of the corresponding commodity; it constitutes all commodities into the super-sovereign currency according to the consensus weight; the list of transaction includes a list of all commodity transactions for some time prior to the operation of the method and system, and the commodity transaction includes the exchange of value for the purchase or sale of physical or virtual goods, the sale and purchase of services, the trading of currencies and other securities; the compliance verification is to generate a compliance verification standard through a consensus mechanism, and verify the compliance of the transaction list according to the standard; the compliance verification standards should include: transaction authenticity, exclusion of internal transaction, and false transaction; the sustainability of transaction requires a certain market supply of goods; the universality of transaction requires that specific transacting objects cannot be limited; the fairness of transaction requires that when the commodity pricing of a certain node deviates significantly from the market price, all trading nodes are allowed to participate freely, and the buyers and sellers determine the priority trading rights according to the quotation of the market price that is acceptable to each other and the quotation time; the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc., to establish a database indexed by the name of commodity; the same commodity refers not only to the same raw material of the manufactured goods, but also to the same or similar functions and performances of the products, the same specifications and models, and the same quality grades; the price labelling is based on the data in the database established by the AI processing of the transaction list, and the same commodity is priced in the basic unit of measurement in different currencies; the consensus weight is that when a super-sovereign currency is generated by all commodities to extract the value features, the invention determines the weight according to the geographical distribution rate, node participation rate, transaction frequency, proportion of the transaction volume, etc. of the commodity in the world trade, and it is recognized by the consensus mechanism.

3. The method and system according to claim 1, wherein it determines the measure of value of the super-sovereign currency; it performs correspondence on the currency to the labeled price of all commodities, and the weighted average is calculated according to the weight of the corresponding commodity; the price labeling of the super-sovereign currency in each currency is completed, and an equivalence relation between different currencies based on the super-sovereign currency is established, namely, the exchange rate; it determines the issuance mechanism of the super-sovereign currency; it realizes cross-currency world trade based on the equivalence relation between different currencies based on the super-sovereign currency, and issues the super-sovereign currency through the world trade activity award or the consensus-recognized physical objects exchange; the cross-currency world trade includes both the trading activities of the currency held by the buyer node and the currency priced by the seller in different currencies, as well as the transaction activities between the consensus-recognized physical objects and the super-sovereign currency between the consensus-recognized super-sovereign currency business enterprise and the respective nodes; a super-sovereign currency business enterprise refers to an enterprise that has a good reputation and at least obtains the consensus recognition of the nodes in the circulation area of the flat currency, has the consensus-recognized physical object as a guarantee, and is willing to carry out transactions between the super-sovereign currency and consensus-recognized physical objects; the consensus-recognized object is a valuable object recognized by the consensus mechanism, including commodities such as gold and silver that can be used as currency, and physical objects that need to be reserved for future development for human development; in addition to cross-currency world trade activities, the world trade activities also include regional economic and trade activities in the same currency.

4. The method and system according to claim 1, wherein the method and system for generating the super-sovereign currency adopts the distributed platform; the software and hardware are launched by the consensus of the originating node, and is announced on the whole network; all subsequent nodes are accessed, in no particular order and pari passu; all nodes can propose optimization and improvement proposals and solutions for software and hardware systems to be recognized and adopted by the consensus mechanism; the operation of the consensus-recognized system software on the hardware of the consensus-recognized super-sovereign currency business enterprise is as the system miscellaneous platform, and all node hardware can perform operation on the consensus-recognized system software to become the node platform.

5. The method and system according to claim 1, comprising the following steps: S1, each node uploads the transaction list to the system platform, wherein the transaction list refers to a list of all commodity transactions for some time prior to the generation of the platform; S2, the invention performs compliance verification on the transaction lists uploaded by all nodes, if the list is in compliance enters step S3, otherwise returns to step S1; S3, the transaction lists in compliance are generated to blocks and are added into the blockchain, and both parties of the transaction are rewarded; S4, it performs AI processing on the transaction list in the blockchain; S5, it determines the weight according to the geographical distribution rate, node participation rate, transaction frequency, proportion of the transaction volume, etc. of the commodity in the world trade, and constitutes all commodities into the super-sovereign currency according to the weight after being recognized by the consensus mechanism; S6, it determines the price and value of the super-sovereign currency; it performs correspondence on the currency to the labeled price of all commodities, and the weighted average is calculated according to the weight of the corresponding commodity; the price labeling of the super-sovereign currency in each currency is completed, and an equivalence relation between different currencies based on the super-sovereign currency is established, namely, the exchange rate; S7, a world trade system with the super-sovereign currency is established as the hub and bridge with the characteristics that the super-sovereign currency naturally has the relation of the exchange rate of each currency; S8, the trading activities include both the same currency and the following cross-currency transactions: when the buyer purchases the commodity from the seller, the currency held by the buyer is converted into the currency priced by the seller to complete the transaction by the equivalence relation of each currency based on the super-sovereign currency; when the currency of the buyer is converted into the currency priced by the seller, the two parties can voluntarily trade directly between the two currencies, or the other party may voluntarily undertake the currency exchange between the buyer and the seller, and the other party converts the currency of the buyer in the transaction into the currency priced by the seller; the consensus-recognized super-sovereign currency business enterprise is responsible for the operation between the consensus-recognized physical objects and the super-sovereign currency: it acquires the consensus-recognized physical objects of the seller, generates and issues the equivalent super-sovereign currency to the seller; it sells the consensus-recognized physical objects of the buyer, withdraws and cancels the equivalent super-sovereign currency from the buyer; S9, the transaction list is uploaded by the node to the system platform, and after passing the compliance verification, the super-sovereign currency is awarded to the two parties according to the consensus-recognized award amount; the award amount is the ratio of ten thousand of the transaction amount in the super-sovereign currency; the super-sovereign currency that is awarded in the node transaction and the super-sovereign currency issued or cancelled by the consensus-recognized super-sovereign currency business enterprise are recorded in the blockchain of the super-sovereign currency list.

6. The method and system according to claim 1, wherein the AI processing comprises A1: an intelligent processing module based on mathematical statistical model must be generated via the consensus mechanism to establish an AI processing system; A2: the AI processing system performs category classification, summary extraction, LDA topic analysis, quality identification, etc. on the transaction list uploaded by the node, acquires as many high-dimensional characteristics as possible for each transaction according to the quantity of goods, origin of raw materials, place of production, quality grade, packaging grade, remaining shelf life, sales scenario, application scenario, and price of wholesale and retail, and performs calculations such as dimensionality reduction, similarity calculation, clustering, etc., to establish a database indexed by the name of commodity; A3: the AI processing system relies on the database to calculate the price of different currencies of the basic unit of the commodity according to the recent average transaction price of the commodity, and realizes price labeling of the same commodity in different currencies.
